(19) United States
(12) Patent Application Publication
(10) Pub. No.: US 2008/0266290 A1
(43) Pub. Date: Oct. 30, 2008

(54) Container3D Control

(75) Inventor: Joshua D. Wagoner, Tacoma, WA (US)

Correspondence Address: LEE & HAYES, PLLC, 421 W. RIVERSIDE AVE, STE 500, SPOKANE, WA, 99201, US

(73) Assignee: IDENTITYMINE INC., Tacoma, WA (US)

(21) Appl. No.: 11/740,518

(22) Filed: Apr. 26, 2007

(51) Int. Cl. G06T 17/00

(52) U.S. Cl. 345/420

(57) ABSTRACT

A Container3D control generates three dimensional (3D) models within a WPF scene. The control collects the objects supplied either explicitly through an Items property or via data binding a data collection to an ItemSource property. Once the objects are collected, 3D models for each of the collected objects are dynamically generated along with a 3D transform indicating the position of the generated 3D models. The 3D transform is used to determine positions in the WPF scene for each 3D model.

### BACKGROUND

Windows Presentation Foundation (WPF) is Microsoft's presentation subsystem for .NET 3.0, which is a key part of the Microsoft Windows Vista operating system. In WPF, applications can operate over many types of data, including simple objects, collection objects, WPF elements, XML data, ADO.NET objects, and objects returned from Web services. To facilitate data visualization and interaction, WPF implements a mechanism that allows the declaratively binding of these types of data sources to an application user interface (UI). More information is available online within the Microsoft Developer Network (MSDN) documentation or WPF at http://msdn2.microsoft.com/en-us/library//aa970268.aspx.

WPF provides a 3D graphics API for building 3D user interfaces. Container3D builds on top of the WPF 3D API and provides 3D layout and the ability to bind any collection of CLR objects to a collection of 3D models within a WPF 3D scene. Layout to layout 3D transitions and animated model position changes that are provided by Container3D are not natively available within WPF. Also there is no native functionality within WPF for generating 3D models from a collection of CLR objects whether data bound or explicitly manipulated by the developer.

### SUMMARY

Three dimensional (3D) models within a WPF scene are generated with a Container3D control. The control receives the objects supplied either explicitly through an Items property or via data binding a data collection to the ItemsSource property. Once the objects are received, 3D models for each of the received objects is dynamically generated along with a 3D transform indicating the position of the generated 3D models. The 3D transform is then used to position 3D models in the WPF scene. The Container3D control supports 3D layout, animated transitions between layouts and generation of 3D models based on binding to a collection of data objects or directly setting the objects into the Items property.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different figures indicates similar or identical items.

FIG. 1 a block diagram depicted a simplified block diagram of the Container3D control functionality.

FIG. 2 is a block diagram depicting selected modules in a computer device that invokes the Container3D control.

FIG. 3 is a diagram of an exemplary process used to implement a Container3D control

FIG. 4 is a diagram of an exemplary display that uses the Container3D control.

### DETAILED DESCRIPTION

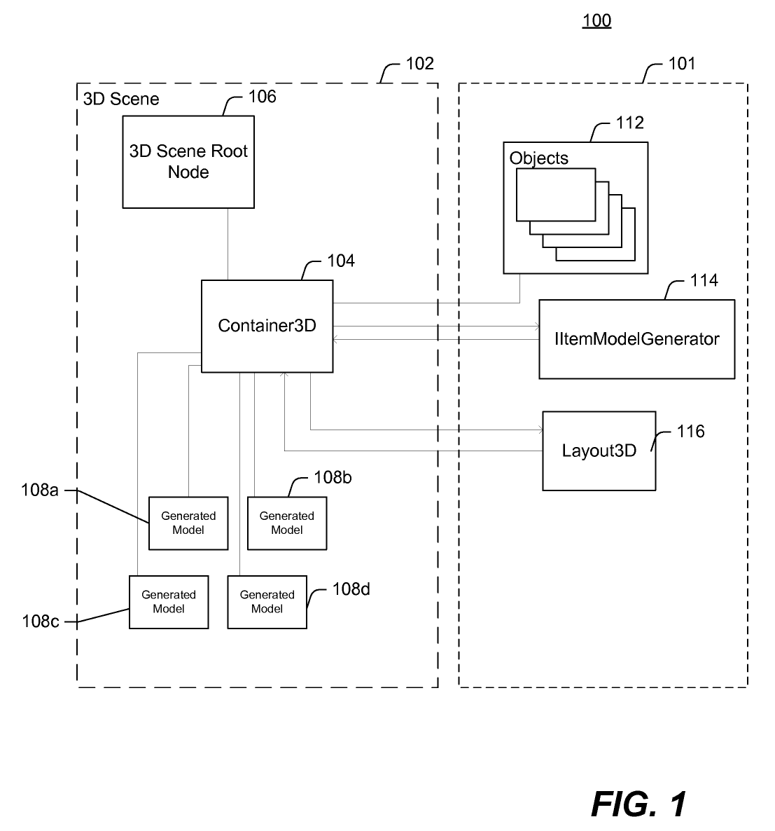

This disclosure is directed to a Container3d control. The Container3D control provides an extensible model generation framework to enable 3D models to be generated for each item contained within the Container3D, whether it is explicitly added to a collection of items or objects of the Container3D or it is implicitly added via a collection data source. The model generation components can determine, in a manner internal to the component, what model to be generate based on the item that is being contained within the Container3D. Further the Container3D control provides 3D layout functionality by providing a framework for layout components to be assigned to an instance of the Container3D. The layout components provide a 3D transform for each model that is a previously generated child of the Container3D. The transform is calculated based on an internal algorithm encapsulated within the layout component. Various examples of the Container3D control are described below with reference to FIGS. 1-4.

FIG. 1 illustrates an example system 100 in which Container3D components 101 are used to create a 3D scene 102. The 3D scene includes a Container3D control 104 coupled to a 3D scene Root Node 106 and generated models 108a-108d. Components 101 include objects 112, IItemModelGenerator 114 and Layout3D control 116, which are coupled with Container3D control 104. Objects 112 are a collection of control Items that can be manually manipulated or bound via the ItemSource property.

### Example System Architecture

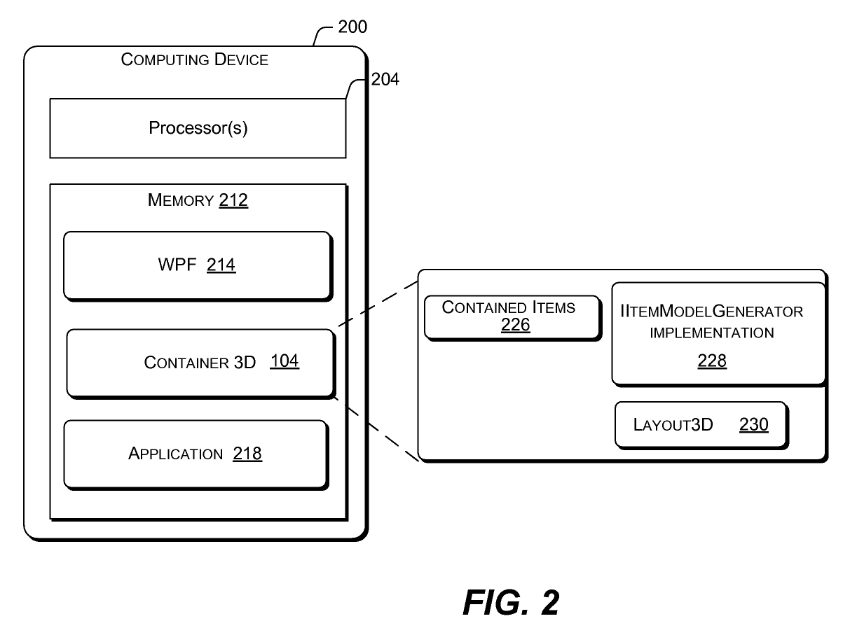

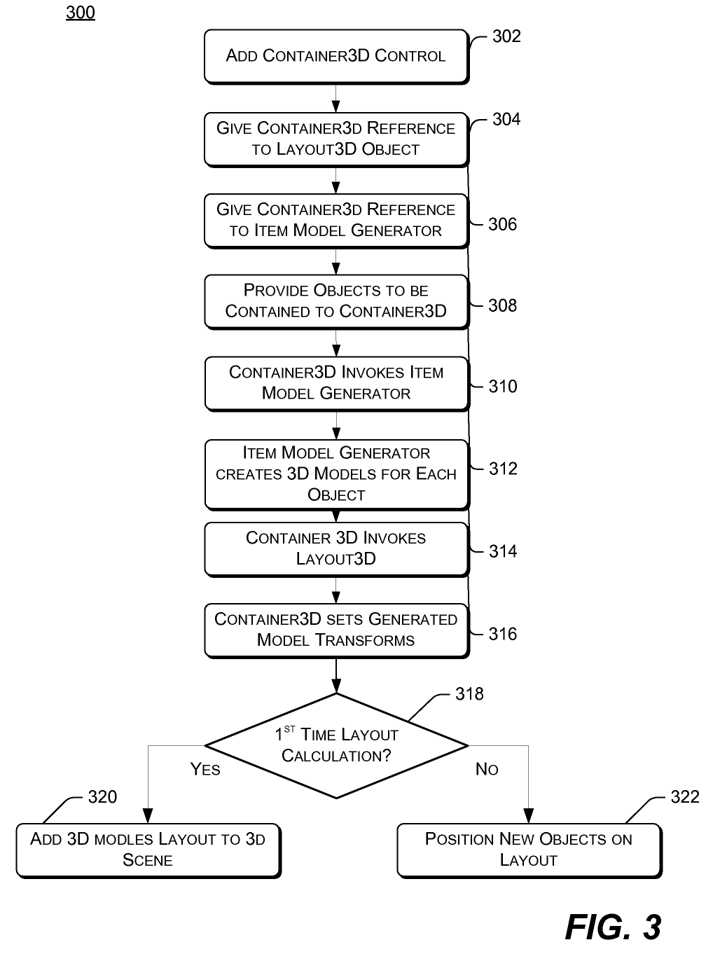

In FIG. 2 are illustrated selected modules in computing device 200 using process 300 shown in FIG. 3. Computing device 200 has process capabilities and memory suitable to store and execute computer-executable instructions. In one example, computing device 200 includes one or more processors 204 and memory 212.

The memory 212 may include volatile and nonvolatile memory, removable and non-removable media implemented in any method or technology for storage of information, such as computer-readable instructions, data structures, program modules or other data. Such memory includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computer system.

Stored in memory 212 of the computing device 200 is Windows Presentation Foundation 214 with an operating system (Such as a Window® Vista based operating system), a Container3D control 104 and a software application 218. Container3D control 104 (also generally referred to as “Container 3D class” or “Container3D”) includes Contained Items 226, IItemModelGenerator implementation 228, and Layout3D 230.

The Container3D class 104 assembles together the Layout3D 230 and IItemModelGenerator implementation 228 and collection of contained items. When a change occurs to a layout referenced by the Container3D 104, the Container3D 104 contains functionality to request new transforms from Layout3D 230 and apply new transforms to each 3D model thereby causing the models to move from one location to the new location. If the Layout3D 230 component referenced by the Container3D 104 is changed to an entirely different Layout3D 230 component, the Container3D 104 contains functionality to animate the transition of the locations of the 3D models to the new layout.

When any change to the collection of items contained within the Container3D 104 (whether that collection is explicitly managed by the developer or whether WPF data binding is managing the collection via a binding to a data collection) the Container3D 104 will generate 3D models according to any changes to the collection of changed items. For example, if one item is added to the collection of contained items and another item is removed from that collection, Container3D 104 will generate a new 3D model, using the referenced IItemModelGenerator implementation, for the new item and at the same time remove the 3D model that was previously generated for the item that was removed from the collection of items. Container3D 104 will then re-evaluate the referenced Layout3D 230 and assign the newly calculated transforms to the generated 3D models.

The Container3D 104 adds and removes the individual models from the actual 3D scene. The generated models are not automatically included into the 3D scene upon generation. After generation of the models, WPF types, such as ModelVisual3D or Model3D objects, are only referenced by the Container3D control 104. The Container3D control 104 adds the generated models to the 3D scene by adding the models to the Children property of Container3D 104. This children property is inherited from the Container3D's base class, ModelVisual3D.

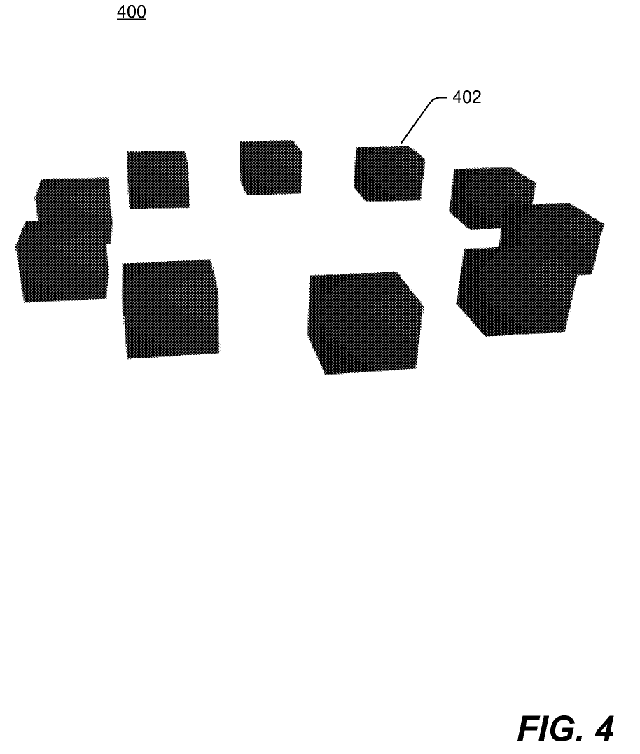

In order for the Container3D 104 itself to be included in a WPF 3D scene it must itself derive from the native WPF ModelVisual3D class. The layout or model generation functionality is not provided by the ModelVisual3D base class. In the example described in FIG. 4, XAML the im:Container3D element is the Container3D component 104.

The IItemModelGenerator implementation 228 generates 3D models for each item contained within the Container3D 104. For each item within the collection of items contained by the Container3D 104, the Container3D 104 will request that the IItemModelGenerator implementation 228 generate a 3D model for the item. In one embodiment, the Item Model generator can return either ModelVisual3D or Model3D objects in response to the Container3D 104 request. Within the framework of the Container3D 104, the item model generators must implement the IItemModelGenerator interface.

The IItemModelGenerator implementation 228 is a component that implements the IItemModelGenerator interface that is a part of the Container3D control 104. The IItemModelGenerator implementation 238 is responsible for generating the 3D models for each item contained within the Container3D 104. For each item within the collection of items contained by the Container3D 104, the Container3D 104, requests that the IItemModelGenerator implementation 228 generate a 3D model for the item by calling the GetItemModel method for each object in the collection of CLR objects contained within the Container3D 104. The GetItemModel method of the IItemModelGenerator implementation 228 can return either ModelVisual3D or Model3D objects in response to the Container3D 104 request. (Note: Both ModelVisual3D and Model3D are objects native to the WPF 3D API that can both be used to represent models that will be rendered in the 3D scene).

In the example XAML in FIG. 4, the IItemModelGenerator implementation 228 is the im:CubeModelGenerator component. When the IItemModelGenerator implementation 228 returns the ModelVisual3D or Model3D object for each item the Container3D 104 can choose whether to wrap that object in another object such as another ModelVisual3D (in the case of a ModelVisual3D or Model3D returned) or a Model3DGroup (in the case of a Model3D returned). Any time that the Container3D 104 requires new models generated, Container3D 104 can call out to the GetItemModel method only for the newly needed models. The IItemModelGenerator implementation 228 can also alert the Container3D 104, by raising the IItemModelGenerator implementation's 228 RegenerationRequired event, that a regeneration of models is required.

Layout3D 230 is the base class for any components that exposes layout logic for consumption by the Container3D 104. When a Layout3D 230 is referenced by a Container3D control 104, the Container3D 104 will request that the Layout3D component calculate a 3D transform for each item contained within the Container3D 104. Container3D 104 passes each item and its corresponding generated model into the Layout3D 230 so that the Layout3D's 230 implementation can contain logic that creates the 3D transform objects based on the actual items or 3D models for which it is calculating transforms.

The Layout3D's 230 GetItemsTransform method is responsible for calculated the 3D transforms for each of the items contained within the Container3D 104. The GetItemsTransform is a method exposed by the Layout3D 230. GetItemsTransform is called by the Container3D 104 when the Container3D 104 requests that the Layout3D 230 calculate the 3D transforms. The Layout3D 230 can return any subclass of the System.Windows.Media.Media3D.Transform3D class, which is a class that is native to the WPF 3D API. When the Transform3D is returned by the Layout3D 230, the Container3D 104 will take that Transform3D object and assign it to the individual models generated by the IItemModelGenerator implementation 228 (or to the object that the Container3D 104 may or may not have chosen to wrap the generated model in).

In the example shown in FIG. 4, XAML the im:EllipseLayout3D element is the Layout3D 230. The Layout3D components can calculate any 3D layout. The Container3D 104 itself has no knowledge of what layout the Layout3D 230 component is calculating it is only aware of the Transform3D returned by the Layout3D 230. The Container3D 104 will request that the Layout3D 230 recalculate the Transform3Ds whenever it determines that the layout should be recalculated. The Layout3D 230 can also alert the Container3D 104 that a recalculation of layout is required through raising the LayoutChanged event of the Layout3D 230 component.

The Container3D 104 supports any type of object as a contained item. There is no requirement that the contained items derive from a certain base class or implement any interface.

The items 226 contained within the Container3D 104 can either be set explicitly via the Items property, which is a collection of CLR objects, or implicitly by binding a collection to an ItemsSource property of the Container3D 104. The ItemsSource property provides a mechanism to assign a collection of data objects to be contained by the Container3D 104. The collection would be bound to the ItemsSource property.

If the collection that is bound to the ItemsSource property raises change events, via the INotifyCollectionChanged interface (the INotifyCollectionChanged interface is native to WPF), the Container3D 104 will respond to those changes by generating new models, if necessary and/or recalculating layout as previously described.

IIlustrated in FIG. 3, is a process 300 for invoking a Container3D control 104. The exemplary process in FIG. 3 is illustrated as a collection of blocks in a logical flow diagram, which represents a sequence of operations that can be implemented in hardware, software, and a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the processes are described with reference to FIG. 1 and FIG. 3, although it may be implemented in other system architectures.

Referring to FIGS. 1 and 3, the Container3D control 104 is added as a node within 3D scene 102 in block 302. In one embodiment, Container3D control is added as a node by adding Container3D control as a child of a native WPF Viewport3D control that renders 3D content. In block 304, the Container3d control 104 is given a reference to a Layout3D object 116. In block 306, the Container3D is given a reference to an Item Model Generator 114 (This is an object that implements IItemModelGenerator). The IItemModelGenerator is an interface that defines a GetItemModel method that is called by Container3D 104 to retrieve generated models. A collection of objects to be contained is given to the Container3D (either explicitly through its Items property or via data binding to a data collection) in block 308.

The container 3D 104 receives objects 112 to be contained from Container3D components 101 and calls out to the IItemModelGenerator implementation's 114 GetItemModel method for each item in its collection of contained items in block 310. Such objects are supplied either explicitly through the Container3D Items property or via data binding to a data collection to the Container3D's ItemsSource property

In block 312, the item model generator 114 creates a 3D model for each item that the Container3D control 104 passes to IItemModelGenerator 114 and returns the models to the Container3D control 104 The Container3D control 104 then invokes the Layout3D object 116 in block 314 and passes the collection of contained items and the collection of generated models to the Layout3D object 116. The Layout3D object 116 then returns to the Container3D control 104 the calculated 3D transforms that will position the generated models at the proper 3D positions on scene 102.

In block 316, Container3D control 104 sets the transforms of each generated model to the 3D transforms calculated by the Layout3D 116. Container3D control 104 determines, in block 318, if this is the first time that the layout was calculated. If it was (“yes” to block 318), in block 320, the 3D models are added to the 3D scene. If this is not the first time the layout was calculated (“no” to block 318), the 3D models are positioned in the new layout in block 322.

### Example Implementation

The following XAML markup is an example of using the Container3D control 104 to generate 3D cube models for each CLR object in a collection bound to the ItemsSource property and to position them in an elliptical layout. The rendering 400 generated by using the control is shown in FIG. 4 with the generated models 402 being arranged in the shape of an ellipse.

```
<im:Container3D>
  <im:Container3D.Layout>
    <im:EllipseLayout3D RadiusX=“7” RadiusY=“5”
    UpDirection=“0,1,0” />
  </im:Container3D.Layout>
  <im:Container3D.ItemModelGenerator>
    <im:CubeModelGenerator />
  </im:Container3D.ItemModelGenerator>
  <im:Container3D.ItemsSource>
    <Binding Source=“{StaticResource ItemData}” />
  </im:Container3D.ItemsSource>
</im:Container3D>
```

In this example, the im:Container3D is the Container3D control 104 itself, the im:EllipseLayout3D is the component that provides the 3D layout (the Layout3D 230), the im:CubeModelGenerator is the item model generator (an implementation of IItemModelGenerator 228) and the Binding with Source=“{StaticResource ItemData}” shows an example of binding a collection of CLR objects to the ItemsSource property of the Container3D 104.

### Conclusion

In closing, although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method for generating 3D models for a scene from a collection of objects, the method comprising:
collecting a plurality of objects;
generating 3D models for each of the collected plurality of objects;
calculating a 3D transform indicating a position of the generated 3D models; and
setting a transform that positions the generated 3D models in virtual space for each of the generated models to the position indicated by the 3D transform.

2. The method as recited in claim 1 wherein the plurality of objects are collected explicitly through an Items property.

3. The method as recited in claim 1 wherein the plurality of objects are collected via a data binding to a data collection.

4. The method as recited in claim 1 wherein when a first time the position is indicated the generated 3D models are added to the scene.

5. The method as recited in claim 1 wherein when the position is indicated a second time, the generated 3D models are repositioned on the scene.

6. A method for generating 3D models with a container 3D control for a scene from a plurality of objects in Windows Presentation Foundation (WPF), the method comprising:
referencing a layout control and a generator control;
providing the plurality of objects to be collected;
invoking the generator control to generate 3D models for each of the collected plurality of objects;
invoking the layout control to calculate a 3D transform indicating the position of the generated 3D models; and
setting a transform that positions the generated 3D models in the scene for each of the generated 3D models.

7. The method as recited in claim 6, further comprising adding a container3D control to a node within the scene.

8. The method as recited in claim 6 wherein the transform positions the generated 3D models at the position calculated by the layout control.

9. The method as recited in claim 6 wherein the plurality of objects are collected explicitly through an Items property.

10. The method as recited in claim 6 wherein the plurality of objects are collected via a data binding to a data collection.

11. The method as recited in claim 6 wherein when a first time the position is calculated the generated 3D models are added to the scene.

12. The method as recited in claim 6 wherein when the position is calculated a second time, the generated 3D models are repositioned on the scene.

13. A computer readable medium comprising computer-executable instructions for generating 3D models for a scene from a collection of objects that, when executed by one or more processors, perform acts comprising:
collecting a plurality of objects;
generating models for each of the collected plurality of objects;
calculating a transform indicating a position of the generated models; and
setting a transform that positions the generated models in virtual space for each of the generated models to the position indicated by the transform.

14. The computer readable medium as recited in claim 1 wherein when a first time a transform is set the generated 3D models are added to the scene.

15. The computer readable medium as recited in claim 13 wherein when a second time the transform is set, the generated 3D models are repositioned on the scene.

16. The computer readable medium as recited in claim 13, wherein the acts are performed using Window Presentation Foundation.
